(19) United States
(12) Patent Application Publication
(10) Pub. No.: US 2016/0224221 A1
(43) Pub. Date: Aug. 4, 2016

(54) APPARATUS FOR ENABLING DISPLACED EFFECTIVE INPUT AND ASSOCIATED METHODS

(71) Applicant: NOKIA TECHNOLOGIES OY, Espoo (FI)

(72) Inventors: Qing Liu, Beijing (CN); Xuwen Liu, Beijing (CN); Ke He, Beijing (CN); Libao Chen, Beijing (CN)

(21) Appl. No.: 14/916,958

(22) PCT Filed: Sep. 11, 2013
(86) PCT No.: PCT/CN2013/083307

§ 371 Date: Mar. 4, 2016

(51) Int. Cl. G06F 3/0484; G06F 3/0481; G06F 3/0482

(52) U.S. Cl. CPC G06F 3/04845; G06F 3/0482; G06F 3/04817; G06F 3/04842

(57) ABSTRACT

An apparatus comprising: a processor; and a memory including computer program code, the memory and the computer program code configured, with the processor, to cause the apparatus to perform at least the following: enable, in response to receiving a present user input associated with a position on a screen of an electronic device, a user to interact with a graphical user interface at a determined displaced effective input position on the screen, wherein the position of the displaced effective input is displaced from the associated present user input screen position and is determined by scaling the displacement vector from a reference position associated with a reference user input to the spaced apart position of the received present user input.

### TECHNICAL FIELD

The present disclosure relates to user interfaces, associated methods, computer programs and apparatus. Certain disclosed aspects/example embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/example embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Certain electronic devices are provided with graphical user interfaces which allow the user to control the functionality of the device. The user generally interacts with the graphical user interface by means of, for example, a mouse, a touch pad or a touch screen.

The listing or discussion of a prior-published document or any background in this specification should not necessarily be taken as an acknowledgement that the document or background is part of the state of the art or is common general knowledge. One or more aspects/example embodiments of the present disclosure may or may not address one or more of the background issues.

### SUMMARY

In a first aspect, there is provided an apparatus comprising:
a processor; and
a memory including computer program code,
the memory and the computer program code configured, with the processor, to cause the apparatus to perform at least the following:
enable, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling the displacement vector from a reference position associated with a reference user input to the spaced apart position of the received present user input.

The apparatus may be configured to determine the position of the displaced effective input with respect to the reference position by scaling the displacement vector by a factor less than 1.

The apparatus may be configured to determine the position of the displaced effective input with respect to the reference position by scaling the displacement vector by a factor greater than 1.

A graphical user interface may comprise one or more graphical user interface elements. A graphical user interface element may comprise a key, an icon (e.g. an application icon), a shortcut, or a menu item.

Some embodiments may be configured to allow the user to interact directly with the graphical user interface at the displaced effective input position (e.g. to open a window at a particular position (at the displaced effective input position) on a home screen by interacting with the home screen itself (at the received present user input screen position)). Some embodiments may be configured to allow the user to interact with graphical user interface elements of the graphical user interface (e.g. to open applications by selecting application icon user interface elements) positioned at the received present user input position or at the displaced effective input position.

The apparatus may be configured to allow the user to interact with the graphical user interface at a determined displaced effective input position on the screen by:
interacting with graphical user interface elements located at the determined effective input position prior to the present user input being received.

The apparatus may be configured to allow the user to interact with the graphical user interface at a determined displaced effective input position on the screen by:
selecting graphical user interface elements at the determined effective input position.

The apparatus may be configured to allow the user to interact with the graphical user interface at a determined displaced effective input position on the screen by:
moving graphical user interface elements to the determined effective input position.

The apparatus may be configured to control the interaction with the graphical user interface in response to detecting additional user inputs. For example, the position of the present user input provided by a first stylus (e.g. a thumb) may be used to control the position of the displaced effective input position whilst the additional user input provided by a second stylus (e.g. a finger) could be used to control the interaction with the graphical user interface at the displaced effective input position. For example, a user could move his thumb to successively position the displaced effective input position over a number of graphical user interface elements. When the displaced effective input position was over a graphical user interface element, the user could select that graphical user interface element by providing an additional selection input (e.g. by tapping on the screen or in a dedicated tapping area, or by pressing a virtual or physical selection key) using his finger. In this way the user could select multiple target objects (e.g. photos in an image gallery for sharing or deletion).

It will be appreciated that the apparatus may be configured to identify user interface elements to allow the user to interact with a position corresponding to an identified user interface element within a predetermined range of the determined displaced effective position (e.g. 0.2-2 cm). This may help the user perhaps interact more quickly with target user interface element she wishes to select or manipulate.

The reference position may correspond to the position of a previously received user input, the previously received user input being a user input which was provided immediately (or within a predetermined time period) before the present user input.

The reference position may correspond to the position of a simultaneously or concurrently received user input, the simultaneously or concurrently received user input being a user input received at least partially overlapping in time with the present user input.

The position of the received present user input, the reference position and/or the effective input may be defined with respect to the screen. The position of the received present user input, the reference position and the effective input may be defined with respect to content displayed on the screen (e.g. with respect to a map image, or a position within a document).

The position of the effective input position may be indicated on the screen by an effective input position indicator. For example, the displacement vector between the effective input position and the received present user input position may be indicated by an arrow. The arrow may be shown e.g. as a user interface element, as semi-transparent, or as a transparent trace.

The apparatus may be configured to enable display an interaction zone, the interaction zone configured to:
have the same shape as the screen or a particular screen portion;
be smaller than the screen or the particular screen portion; and
be orientated with respect to the reference position,
such that a user input position within the interaction zone is associated with a corresponding determined displaced effective input position on the screen or the particular screen portion. A particular screen portion may correspond to a window or a portion of the screen dedicated to a particular application, file, or software widget.

The apparatus may be configured to receive a said user input associated with a position on a screen from at least one of:
a mouse;
a keyboard;
a joystick;
a touchpad; and
a touch screen.

The apparatus may comprise the screen.

The apparatus may be the electronic device, a portable electronic device, a laptop computer, a mobile phone, a Smartphone, a tablet computer, a personal digital assistant, a digital camera, a watch, a server, a non-portable electronic device, a desktop computer, a monitor, a server, a wand, a pointing stick, a touchpad, a touch-screen, a hover touch screen, a mouse, a joystick or a module/circuitry for one or more of the same.

According to a further aspect, there is provided a method comprising:
enabling, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling the displacement vector from a reference position associated with a reference user input to the spaced apart position of the received present user input.

According to a further aspect, there is provided a computer program comprising computer program code configured to:
enable, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling the displacement vector from a reference position associated with a reference user input to the spaced apart position of the received present user input.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product.

According to a further aspect, there is provided an apparatus comprising:
means for enabling configured to enable, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling the displacement vector from a reference position associated with a reference user input to the spaced apart position of the received present user input.

According to a further aspect, there is provided an apparatus comprising:
an enabler configured to enable, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling the displacement vector from a reference position associated with a reference user input to the spaced apart position of the received present user input.

According to a further aspect, there is provided an apparatus comprising:
a processor; and
a memory including computer program code,
the memory and the computer program code configured, with the processor, to cause the apparatus to perform at least the following:
enable, in response to receiving a present user input associated with a position on a screen of an electronic device, a user to interact with a graphical user interface at a determined displaced effective input position on the screen, wherein the position of the displaced effective input is indicated by an arrow (or arrow-like) element.

According to a further aspect, there is provided a method comprising:
enabling, in response to receiving a present user input associated with a position on a screen of an electronic device, a user to interact with a graphical user interface at a determined displaced effective input position on the screen, wherein the position of the displaced effective input is indicated by an arrow (or arrow-like) element.

According to a further aspect, there is provided a computer program comprising computer program code configured to:
enable, in response to receiving a present user input associated with a position on a screen of an electronic device, a user to interact with a graphical user interface at a determined displaced effective input position on the screen, wherein the position of the displaced effective input is indicated by an arrow (or arrow-like) element.

As described above, the position of the displaced effective input is displaced from the associated present user input screen position and may be determined by scaling the displacement vector from a reference position associated with a reference user input to the spaced apart position of the received present user input.

The arrow or arrow-like element may indicate the displacement vector from the present user input position to the determined displaced effective input position. The arrow or arrow-like element may indicate the displacement vector from the reference position to the determined displaced effective input position.

In addition to, or instead of, visually indicating the position of the displaced effective input, the position may be indicated using audio, visual, tactile feedback, haptic feedback and/or the like. E.g. a tactile vibrating feedback may indicate the position and differ based on the user interface element the displaced effective input position is at.

The present disclosure includes one or more corresponding aspects, example embodiments or features in isolation or in various combinations whether or not specifically stated (including claimed) in that combination or in isolation. Corresponding means and corresponding function units (e.g. an input receiver, an input enabler) for performing one or more of the discussed functions are also within the present disclosure.

Corresponding computer programs for implementing one or more of the methods disclosed are also within the present disclosure and encompassed by one or more of the described example embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus comprising a number of electronic components, including memory and a processor according to an example embodiment disclosed herein;

FIG. 2 illustrates an example apparatus comprising a number of electronic components, including memory, and a processor according to another example embodiment disclosed herein;

FIG. 3 illustrates an example apparatus comprising a number of electronic components, including memory, a processor and a communication unit according to another example embodiment disclosed herein;

FIGS. 4a-4d illustrate a first example embodiment configured to enable a user to interact with a graphical user interface at a determined displaced effective input position on the screen;

FIGS. 5a-5d illustrate a further example embodiment configured to enable a user to interact with a graphical user interface at a determined displaced effective input position on the screen;

FIGS. 6a-6d illustrate a further example embodiment configured to enable a user to interact with a graphical user interface at a determined displaced effective input position on the screen;

FIGS. 7a-7b illustrate an example apparatus in communication with a remote server/cloud according to another example embodiment disclosed herein;

FIG. 8 depicts a method according to an example embodiment; and

FIG. 9 illustrates schematically a computer readable medium providing a program.

### DESCRIPTION OF EXAMPLE ASPECTS/EMBODIMENTS

Certain electronic devices provide one or more functionalities. For example, a mobile telephone may be used to make calls and to listen to music. Generally, such an electronic device is provided with a graphical user interface to control the various functionalities. For example, the user may navigate through a menu or interact with icons in order to select whether, for example, the call function is to be activated or the music player function. For example, to make a call on a touch screen phone may require that the user first unlocks the screen, then finds the ‘call application’, then dials.

When interacting with a graphical user interface, there may be occasions when a user is providing input corresponding to a particular region of the screen but wishes to interact with a position which is far away from the position of your input. For example, if a user wanted to move a number of files from one side of the screen to the other, they may need to select them all and drag them across the entire width of the screen, or they may drag each file across the screen one by one. This may be time consuming and tedious for the user.

In other cases, a user may wish to interact with a very precise portion of the screen (e.g. when selecting a particular website link from a webpage displayed in a small font). In such cases, it may be difficult for a user to ensure that he does not inadvertently interact with the wrong portion of the screen (e.g. by inadvertently selecting the wrong link when interacting with a touch screen using a finger or thumb). Therefore, it may be advantageous for a user to be able to increase the accuracy of his interactions with the screen.

In addition, for graphical user interfaces configured to allow the user to interact with the graphical user interface at a position which is the same as the user input, the user input itself may obscure the desired portion of the graphical user interface. For example, when using a touch screen user interface, when selecting a particular user interface element with a finger, the finger may obscure which user interface element is being selected.

Examples disclosed herein may be considered to provide a solution to one or more of the abovementioned issues by providing an apparatus configured to enable, in response to receiving a present user input associated with a position on a screen of an electronic device, a user to interact with a graphical user interface at a determined displaced effective input position on the screen, wherein the position of the displaced effective input is displaced from the associated present user input screen position and is determined by scaling the displacement vector from a reference position associated with a reference user input to the spaced apart position of the received present user input.

Other examples depicted in the figures have been provided with reference numerals that correspond to similar features of earlier described examples. For example, feature number 101 can also correspond to numbers 201, 301 etc. These numbered features may appear in the figures but may not have been directly referred to within the description of these particular examples. These have still been provided in the figures to aid understanding of the further examples, particularly in relation to the features of similar earlier described examples.

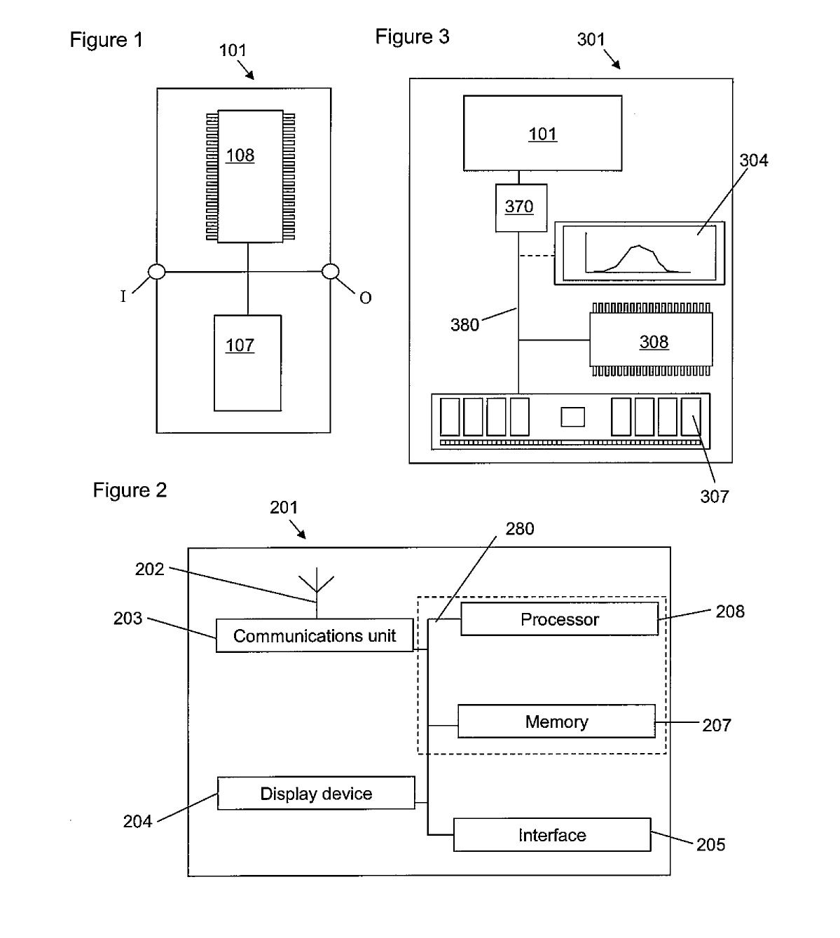

FIG. 1 shows an apparatus 101 comprising memory 107, a processor 108, input I and output O. In this example embodiment only one processor and one memory are shown but it will be appreciated that other example embodiments may utilise more than one processor and/or more than one memory (e.g. same or different processor/memory types).

In this example embodiment the apparatus 101 is an Application Specific Integrated Circuit (ASIC) for a portable electronic device with a touch sensitive display. In other example embodiments the apparatus 101 can be a module for such a device, or may be the device itself, wherein the processor 108 is a general purpose CPU of the device and the memory 107 is general purpose memory comprised by the device.

The input I allows for receipt of signalling to the apparatus 101 from further components, such as components of a portable electronic device (like a touch-sensitive display) or the like. The output O allows for onward provision of signalling from within the apparatus 101 to further components such as a display screen. In this example embodiment the input I and output O are part of a connection bus that allows for connection of the apparatus 101 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 201 of a further example embodiment, such as a mobile phone. In other example embodiments, the apparatus 201 may comprise a module for a mobile phone (or other portable electronic device), and may just comprise a suitably configured memory 207 and processor 208. The apparatus in certain example embodiments could be the electronic device, a portable electronic device, a laptop computer, a mobile phone, a Smartphone, a tablet computer, a personal digital assistant, a digital camera, a navigator, a server, a non-portable electronic device, a desktop computer, a monitor, a table-top display, an interactive display, a refrigerator, or a module/circuitry for one or more of the same.

The example embodiment of FIG. 2, in this case, comprises a display device 204 such as, for example, a Liquid Crystal Display (LCD), e-link, a hover touch or touch-screen user interface. The display device 204 may be a bendable, foldable, and/or rollable flexible display. The display device 204 may be curved (for example as a flexible display screen or as a rigid curved glass/plastic display screen). The display device 204 (and/or the device 201) may be any shape, such as rectangular, square, round, star-shaped or another shape. A device such as device 201 configured for touch user input may be configured to receive touch input via a touch detected on a touch-sensitive screen, on a separate touch-sensitive panel, or on a touch sensitive front window/screen integrated into the device 201, for example. A touch-sensitive detector may be any shape, and may be larger than a display screen of the apparatus/device in some examples.

The apparatus 201 of FIG. 2 is configured such that it may receive, include, and/or otherwise access data. For example, this example embodiment 201 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 201 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data). In other cases where the apparatus 201 is a peripheral device, the communication unit 203 and/or antenna 202 may be configured for Bluetooth™ connection to an electronic device.

FIG. 3 depicts a further example embodiment of an electronic device 301, such as a mobile phone, a portable electronic device, a portable telecommunications device, a server or a module for such a device, the device comprising the apparatus 101 of FIG. 1. The apparatus 101 can be provided as a module for device 301, or even as a processor/memory for the device 301 or a processor/memory for a module for such a device 301. The device 301 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code.

The apparatus 101 in FIG. 3 is connected (e.g. electrically and/or wirelessly) to an input/output interface 370 that receives the output from the apparatus 101 and transmits this to the device 301 via data bus 380. Interface 370 can be connected via the data bus 380 to a display 304 (touch-sensitive or otherwise) that provides information from the apparatus 101 to a user. Display 304 can be part of the device 301 or can be separate. The device 301 also comprises a processor 308 configured for general control of the apparatus 101 as well as the device 301 by providing signalling to, and receiving signalling from, other device components to manage their operation.

The storage medium 307 is configured to store computer code configured to perform, control or enable the operation of the apparatus 101. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

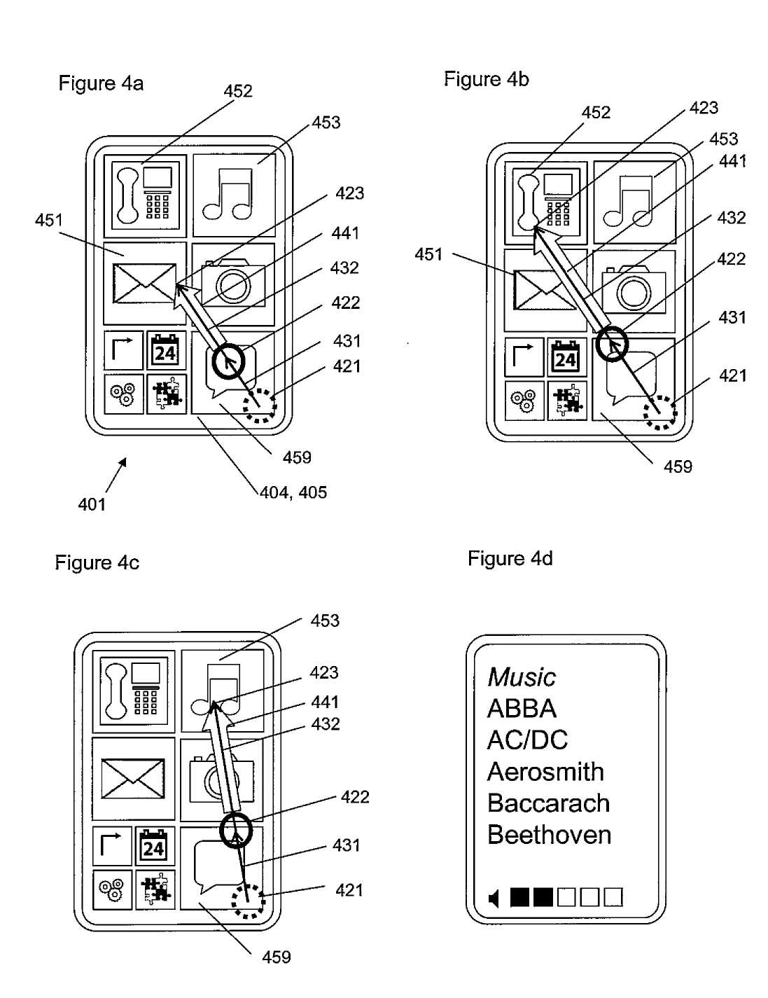

FIGS. 4a-4d illustrate the front of an example embodiment of a portable electronic device 401 such as a mobile telephone or smartphone. The portable electronic device 401 may be the apparatus or may comprise the apparatus. In this case, the device comprises a touch screen 404, 405 configured to enable the user to interact with the graphical user interface.

In the situation depicted on FIG. 4a, the touch screen 404, 405 is displaying a graphical user interface comprising a variety of user interface elements including a number of application icons, including an email application icon 451, a phone application icon 452, and a music player application icon 453. In this case, the user is holding the device in his left hand and interacting with the device using his right hand.

In this example, the user wishes to select the music player application icon 453. In this case, the device is configured to enable selection of a user interface element (e.g. an application icon) in response to detecting completion of a touch user interaction associated with the user interface element (e.g. detecting the completion of a user interaction by a user lifting his finger or other stylus away from the touch screen or out of hover range of the touch screen 404, 405).

This example embodiment is configured to enable, in response to receiving a present user input associated with a position on a screen of an electronic device, a user to interact with a graphical user interface at a determined displaced effective input position on the screen, wherein the position of the displaced effective input is displaced from the associated present user input screen position and is determined by scaling the displacement vector from a reference position associated with a reference user input to the spaced apart position of the received present user input.

In the situation depicted in FIG. 4a, the user has initiated a finger interaction 422 on the touch screen using his finger, and a thumb interaction 421 using his thumb. It will be appreciated that other example embodiments may be configured to detect the interaction with other styli such as mechanical styli. This example embodiment is configured to recognise the position of the thumb interaction reference input (the associated reference position being the centre of the dotted circle shown in FIG. 4a) as the reference position 421, and the finger interaction position (the position being the centre of the solid circle shown in FIG. 4a) as the present input position 422. That is, in this case, the reference position 421 is the position of a simultaneously/concurrently received (thumb) user input, the simultaneously/concurrently received user input being a user input received at least partially overlapping in time with the present (finger) user input 422. It will be appreciated that the received present user input 422 is spaced apart from the reference position 421.

The apparatus/device is configured to determine a displacement vector, \vec{S}_{R→P} (431), from the reference position 421, R, to the present user input screen position 422, P, associated with the present input.

The apparatus/device in this case is configured to determine (e.g. by using a calculation) the position of the displaced effective input, \vec{R}_{E} (423), by scaling, by a scale factor, f, the displacement vector, \vec{S}_{→P} (431), from a reference position, \vec{R}_{R}, associated with a reference user input to the spaced apart position of the received present user input, \vec{R}_{P}. That is:

\vec{R}_{E}=\vec{S}_{R→E}+\vec{R}_{R}=f×\vec{S}_{R→P}+\vec{R}_{R}, (equation 1)

where \vec{S}_{R→E} (432) is the displacement vector from the reference position 421, \vec{R}_{R}, to the displaced effective input position 423, \vec{R}_{E}.

Determining the position of the displaced effective input relative to the reference point with a scale factor f, may be considered equivalent to determining the position of the displaced effective input with reference to the present input position with a scale factor f−1. That is:

\vec{R}_{E}=f×\vec{S}_{R→P}+\vec{R}_{R}=f×\vec{S}_{R→P}+(\vec{R}_{P}−\vec{S}_{R→P})=(f−1)×\vec{S}_{R→P}+\vec{R}_{P}. (equation 2)

For example, a sale factor, f, of 1.1 would position the displace the effective user input position 0.1 times the displacement vector between the reference position and the present user input position away from the present user input position; and 1.1 times the displacement vector between the reference position and the present user input position away from the reference position.

It will be appreciated that the value of the scale factor may be preset by the user, an application (e.g. such that the scale factor is different for different applications), the operating system, or the apparatus.

It will be appreciated that other example embodiments may be configured to receive the determined displacement vector from a remote server. For example, the input received on the screen may be first transmitted to a server (which may be remote from the screen, electronic device and/or apparatus). The server may then determine the displacement vector \vec{S}_{RP} and/or the scaled displacement vector \vec{S}_{R→E}, and the determined at least one displacement vector may then be transmitted from the server to the apparatus.

It will be appreciated that the scale factor, f, may be a constant (e.g. a constant between 1.1 and 3.0), or may vary (e.g. depending on the size of the displacement vector \vec{S}_{R→P} (431), on the reference position \vec{R}_{R} (421), and/or on the present input position \vec{R}_{P} (422)). In this case, the scaling factor f for scaling the displacement vector \vec{S}_{R→P} is greater than 1. This means that the displaced effective input is positioned such that the present input position lies between the displaced effective input position and the reference position.

It will be appreciated that when using a constant scale factor of 2 (with a fixed reference position), for example, a movement of the present user input position by 1 mm would move the determined displaced effective input position by 2 mm. That is:

Δ\vec{R}_{E}=\vec{R}_{E}(final)−\vec{R}_{E}(initial)=f×[\vec{R}_{P}(final)−\vec{R}_{P}(initial)]=2×Δ\vec{R}_{P} (equation 3)

Likewise, when using a constant scale factor of 4, for example, a movement of the present user input position by 1 mm would move the determined effective input position by 4 mm. That is, when f=4, Δ\vec{R}_{E}=4×Δ\vec{R}_{P}.

In FIG. 4a, although the present user input 422 corresponds to a position within the messaging icon 459, if the user were to complete the dragging gesture at this position (e.g. by lifting his finger from the touch screen) the apparatus would be configured to select the email application icon 451 (because the effective input position is within the email application icon 451) and thereby open the email application.

In order to indicate the position of the displaced effective input position, this embodiment is configured to show (or enable display of) an arrow 441 from the present user input position 422 to the displaced effective input position 423.

As the user continues the dragging gesture away from the reference position 421 in the same direction as the displacement vector \vec{S}_{R→P} (as shown in FIG. 4b), the apparatus is configured to update the position of the effective displaced input 423. It will be appreciated that, for this embodiment, the position of the effective input 423 is based on the position of the present input position 422 and the reference position 421 (and not, for example, on how the user has provided input between these two position). Although the present user input corresponds to a position 422 within the messaging icon 459, if the user were to complete the dragging gesture at this position, the apparatus would be configured to select the phone application icon 452 because the displaced effective user input position 423 is within the area of the phone application icon 452 (as shown in FIG. 4b). That is, in this case, the apparatus/device is configured to allow the user to interact with the graphical user interface at a determined displaced effective input position on the screen by interacting with graphical user interface elements (e.g. application icons) located at the determined effective input position 423 prior to the present user input being received.

To select the desired music application 453, the user moves the present input position to change the direction of the displacement vector \vec{S}_{R→P} (431) (as shown in FIG. 4c). Because the direction of the displacement vector \vec{S}_{R→P} (431) is changed, the direction of the scaled displacement vector \vec{S}_{R→E} (432) used to determine the position of the effective user input 423 is correspondingly changed. For example, moving the stylus to cause angular rotation of the present input position (clockwise/anti-clockwise movement) around the reference position correspondingly rotates the displaced effective input position (and arrow indicator 441). It will be appreciated that the position of the displaced effective user input position (and the arrow) may also change when the user slides the thumb to move it from a target element to another (i.e. by normally moving the thumb/stylus around the screen). This allows the user to interact with the music player application icon 453 even whilst providing the present user input 422 within the area of the messenger application icon 459.

When the user sees that the effective input position 423 is located within the desired music player application icon 453, the user completes the dragging input gesture (in this case by lifting his finger away from the touch screen). In response to detecting completion of the dragging input gesture, the apparatus is configured to enable selection of the user interface element at the displaced effective user input position 423. In this case, the music player application icon 453 is selected and the music application is opened. This is shown in FIG. 4d.

It will be appreciated that some example embodiments may be configured to allow the reference position to be changed. For example, for embodiments wherein the reference position corresponds to the position of a simultaneously received user input, reference position (and associated displacement vectors \vec{S}_{R→P} and \vec{S}_{R→E}) may be changed by moving the position of the simultaneously received user input.

Other example embodiments may be configured such that the reference position corresponds to be the position of a previously received user input (e.g. a previous user input which may be a user input immediately preceding the present user input). For example, a previously received user input may be a contact input which initiates a dragging gesture user interaction. A subsequent dragging input from the initiation position may be considered to be the received present user input.

This may allow the user input to be provided using a single gesture (e.g. using a single stylus). When interacting with a touch screen using a single stylus (e.g. the thumb of the hand holding the device), the area of the touch screen with which the user can interact may be limited. For example, the user may not be able to reach the area at the top right of the screen when using the thumb of his left holding hand. Providing a displaced effective input position may allow a user to interact with more of the screen.

That is, the user may be able to use one stylus (e.g. one finger or one thumb) to perform a complex task. For example, the user could touch the thumb to the screen and then move the thumb on the screen. The apparatus would use the touch initiation point as the reference position and use the current touch position as the present input position. Removing the thumb from the screen (thereby completing the move gesture) may enable selection of a user interface element corresponding to the last displaced effective input position. It will be appreciated that other example embodiments may be configured to enable selection in response to the present user input remaining stationary (at a particular position) for a time period exceeding a predetermined time period (e.g. between 0.2 and 2 seconds). To cancel an input, a gesture may be performed, e.g. the user could do a swipe input towards the edge of the display/screen/device and lift off the stylus without selecting a user interface element.

In an example embodiment to reach far-away targets, the indicator 441 may change in size. For example after initially activating the displaced input selection mode an arrow indicator having length of 10 pixels (or 1 cm etc.) may be displayed. When user moves the input (hovering, or a touching input e.g. with a stylus/thumb/finger or any other input element) away from the initial input point, the length of the indicator 441 increases and enables the user to select targets further away on the screen without having to move the stylus as much.

In another example embodiment, when the device orientation is portrait, and the input occurs substantially vertical direction (in up-down/down-up direction), the indicator 441 may increase or decrease in length depending on the sliding/moving input direction. When the input movement is horizontal the indicator 441 may increase/decrease in length with a different scale factor (or proportion). That is, in some example embodiments the scale factor may be anisotropic/directionally dependent. (Of course, in other example embodiments, the scale factor may be isotropic, being the same regardless of direction.)

For example, the scale factor along a particular axis may be anisotropic/directionally dependent by being related to (e.g. proportional to) the size of the screen along that axis. For example, for a screen with an aspect ratio of 3:2, moving the present input position by 1 mm parallel to the long edge of the screen may move the displaced effective input position by 3 mm parallel to the long edge, and/or moving the present input position by 1 mm parallel to the short edge of the screen may move the displaced effective input position by 2 mm parallel to the short edge.

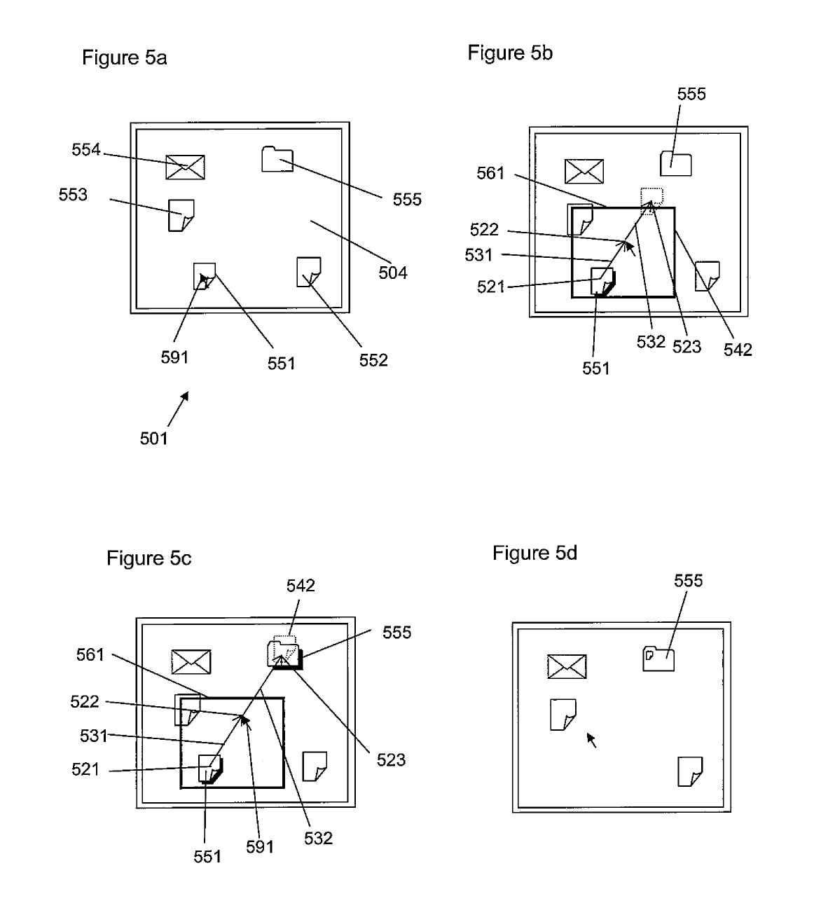

FIGS. 5a-5d illustrate the screen of an example embodiment of an electronic device 501 such as a desktop computer. The portable electronic device 501 may be the apparatus or may comprise the apparatus.

In the situation depicted on FIG. 5a, the screen is displaying a graphical user interface comprising a variety of user interface elements including a number of files 551-553, an email message 554, and an empty folder 555. In this case, the user is interacting with the device using a mouse which controls a cursor 591 on the screen 504. It will be appreciated, that other example embodiments may be configured to allow the user to interact with a screen via a touchpad and/or a joystick.

In this case, the user wishes to move a file 551 into the empty folder 555. In this case, the device is configured to enable a user interface element (e.g. a file, email message or folder) to be moved into a folder in response to the user interface element being moved within the area of the graphical user interface taken up by the folder.

This example embodiment is configured to enable, in response to receiving a present user input associated with a position on a screen of an electronic device, a user to interact with a graphical user interface at a determined displaced effective input position on the screen, wherein the position of the displaced effective input is displaced from the associated present user input screen position and is determined by scaling the displacement vector from a reference position associated with a reference user input to the spaced apart position of the received present user input.

To move the file 551 the user has initiated a dragging user interaction (depicted in FIG. 5b) at a position corresponding to the file 551 to be moved by moving the cursor 591 to the position of the file (using the mouse) and pressing the left mouse button. This selects the file 551. The apparatus/device is configured to indicate that the file 551 has been selected by providing a shadow to the file icon 551 (as shown in FIG. 5b). The user has continued with the dragging gesture by moving the cursor (using the mouse) away from the initiation position whilst continuing to press the left mouse button.

In this case, the reference position 521 corresponds to the position of the cursor when the user first depresses the left mouse button to initiate the dragging gesture.

The apparatus/device is configured to determine a displacement vector, \vec{S}_{R→P} (531), from the reference position 521, R, to the present user input screen position 522, P, associated with the present input.

The apparatus/device in this case is configured to determine the position of the displaced effective input 523, \vec{R}_{E}, using equation 1. In this case, the displacement vector 531, \vec{S}_{R→P}, is from the position of the reference position 521 \vec{R}_{R}, to the spaced apart position of the received present user input 522, \vec{R}_{P} and \vec{S}_{R→E} (532) is the displacement vector from the reference position 521, \vec{R}_{R}, to the displaced effective input 523, \vec{R}_{E}.

As disclosed for the embodiment of FIGS. 4a-4d, it will be appreciated that other example embodiments may be configured to receive the determined displacement vector from a remote server.

In this case, the scaling factor f for scaling the displacement vector \vec{S}_{R→p} is 2. It will be appreciated that f may be a constant (as is the case here), or may vary (e.g. depending on the size of the displacement vector \vec{S}_{R→P}, or on the position of the screen of \vec{R}_{R} and/or \vec{R}_{P}).

To help the user visualise where the effective input position is, the apparatus is configured to enable display of an interaction zone 561, wherein interaction zone is configured to:
have the same shape as the screen;
be smaller than the screen; and
be orientated with respect to the reference position,
such that a user input position within the interaction zone is associated with a corresponding determined displaced effective input position on the screen.

In this case, the area of the interaction zone is configured to be a quarter of the area of the screen. That is, the interaction zone is smaller by a factor of 2 (which in this case, is the same as the scale factor f for determining the displaced effective input position) in each of the two dimensions. In addition, the interaction zone is orientated such that the reference position occupies the same relative position within the interaction zone as it does in the screen (e.g. if the reference position is a quarter of the screen width from the left of the screen, the reference is also a quarter of the interaction zone from the left of the interaction zone). This means that the present user interaction 522 has the same relative position within the interaction zone 561 as the position of the displaced effective user input position 523 has within the screen 504.

It will be appreciated that in other example embodiments, the interaction zone may correspond to a portion of the screen (e.g. to a window).

In addition, the position of the effective input position 523 is indicated on the screen by an effective input position indicator 542. The effective input position indicator 542, in this case, is a translucent version of the file icon 551 to be moved indicating the position the file would have if the dragging gesture were to be completed at that time. It will be appreciated that other example embodiments may be configured to indicate the position of the displaced effective input position using an arrow, or arrow-like, element. For example, an arrow may be displaced corresponding to the displacement vector from the reference position to the displaced effective input position.

In FIG. 5b, although the present user input 522 corresponds to a position within the interaction zone 561, if the user were to complete the dragging gesture at this position (e.g. by lifting his finger from the touch screen), the apparatus would be configured to move the selected file outside the interaction zone 561.

To move the selected file 551 to the empty folder 555, the user moves the present input position 522 to change the direction and size of the displacement vector \vec{S}_{R→P} (531) (as shown in FIG. 5c). Because the size and direction of the displacement vector \vec{S}_{R→p} (531) changes, the direction of the scaled displacement vector \vec{S}_{R→E} (532) giving the position of the effective user input 523 is correspondingly changed.

When the user sees that the effective input position 523 is located within the folder icon 555 (this is indicated to the user by a shadow being provided to the folder icon as shown in FIG. 5c), the user completes the dragging input gesture. In response to detecting completion of the dragging input gesture, the apparatus is configured to enable the selected file user interface element 551 to be moved to the effective user input (folder) position 523.

This results in the file 551 being moved into the empty folder 555. This is shown in FIG. 5d. The folder icon is updated to indicate that it now contains a file.

It will be appreciated that enabling a user to interact with a graphical user interface at a determined displaced effective input position on the screen, the user can interact with a much larger area of the user interface than he may be able readily to reach directly.

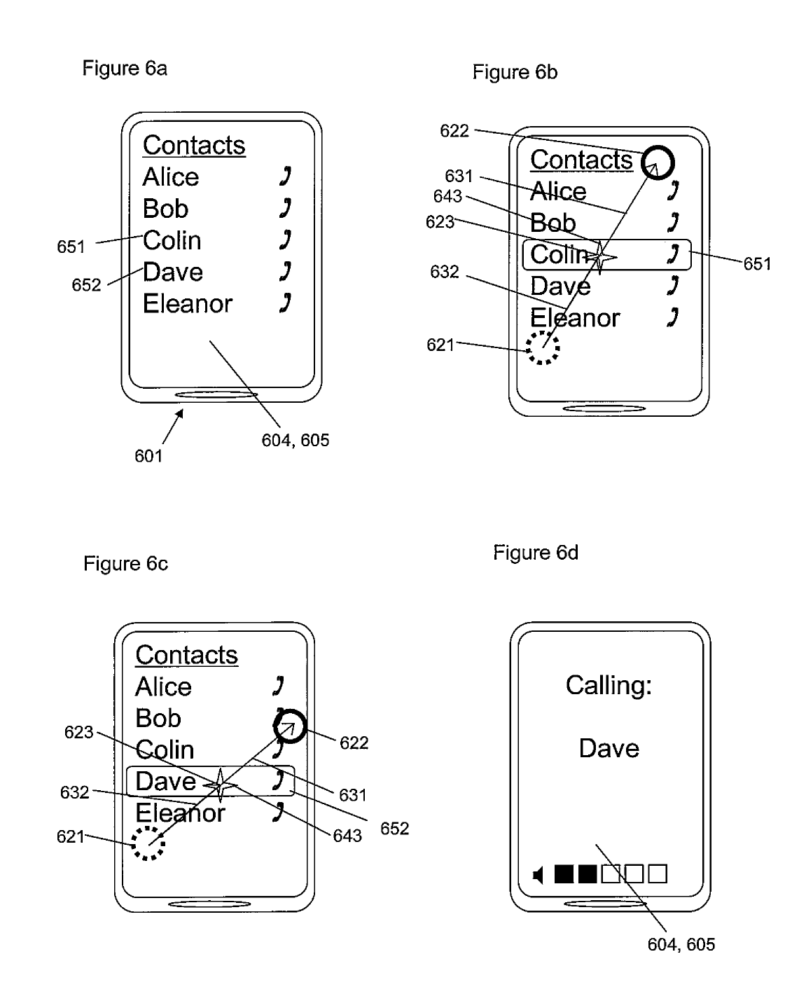

FIGS. 6a-6d illustrate the screen of an example embodiment of a electronic device 601 such as a smartphone. The portable electronic device 601 may be the apparatus or may comprise the apparatus. In this example embodiment, the user can interact with the graphical user interface via a touch screen 604, 605.

In the situation depicted on FIG. 6a, the touch screen 604, 605 is displaying a graphical user interface comprising a variety of user interface elements 651, 652 corresponding to phone contacts which can be selected in order to initiate a phone call.

In this case, the user wishes to select the Dave contact user interface element 652 in order to call Dave. In this case, the device is configured to enable selection of a user interface element (e.g. an contact user interface element) in response to the user completing a touch interaction associated with the user interface element (e.g. detecting the completion of a user interaction by a user lifting his finger or other stylus away from the touch screen or out of hover range of the touch screen).

This example embodiment is configured to enable, in response to receiving a present user input associated with a position on a screen of an electronic device, a user to interact with a graphical user interface at a determined displaced effective input position on the screen, wherein the position of the displaced effective input is displaced from the associated present user input screen position and is determined by scaling the displacement vector from a reference position associated with a reference user input to the spaced apart position of the received present user input.

In the situation depicted in FIG. 6a, the user has provided a double tap user input at a position on the touch screen user interface. It will be appreciated that other example embodiments may be configured to detect the interaction with other styli such as fingers or mechanical styli. This example embodiment is configured to recognise the position of the double tap user input as the reference position 621. The user then provides a present user input 622 by holding his finger (or other stylus) within the detection range of the touch screen for a period of time exceeding a predetermined threshold (e.g. 0.5 seconds). That is, the reference position 621 corresponds to the position of a previously received user input, the previously received user input (e.g. the initiation of the dragging user interaction) being a user input which was provided immediately before the present user input 622. Again, the reference position 621 is spaced apart from the received present user input 622.

In response to detecting the present user input 622 the apparatus/device is configured to determine a displacement vector, \vec{S}_{R→P} (631), from the reference position 621, R, to the present user input screen position 622, P, associated with the present input.

The apparatus/device in this case is configured to determine the position of the displaced effective input 623, \vec{R}_{E}, using equation 1. In this case, the displacement vector, S_{R→P} (631), is from a reference position, \vec{R}_{R}, associated with a reference user input 621 to the spaced apart position of the received present user input 622, and \vec{S}_{R→E} (632) is the displacement vector from the reference position 621, \vec{R}_{R}, to the displaced effective input 623, \vec{R}_{E}.

As described previously, it will be appreciated that other example embodiments may be configured to receive the determined displacement vector from a remote server.

It will be appreciated that f may be a constant, or may vary (e.g. depending on the size of the displacement vector \vec{S}_{R→P}, or on the position of the screen of \vec{R}_{R} and/or \vec{R}_{P}). In this case, the scaling factor f for scaling the displacement vector \vec{S}_{R→P} is less than 1. This means that the position of the effective input position 623 lies between the present user input position 622 and the reference position 621.

By using a scale factor less than one the user may have more precise control of the position of the effective input. For example, a relatively large movement of the present input position will correspond to a relatively small movement of the effective input position. This may allow a user to more easily select a particular user interface element from a number of nearby user interface elements.

In the situation shown in FIG. 6b, although the present user input 622 is outside the selectable contact user interface elements, if the user were to complete the contact input at this position (e.g. by lifting his finger from the touch screen), the apparatus would be configured to select the Colin contact 623.

In order to indicate the position of the displaced effective input position, this embodiment is configured to provide a star 643 at the position of the displaced effective input position. It will be appreciated that other example embodiments may be configured to indicate the position of the displaced effective input position using an arrow, or arrow-like, element. For example, arrows may be displaced corresponding to the displacement vector from the reference position to the displaced effective input position and/or from the present input position to the displaced effective input position.

To select the desired Dave contact user interface element 652, the user moves the present input position to change the size and direction of the displacement vector \vec{S}_{R→p} (631) (as shown in FIG. 6c). Because the direction of the displacement vector is changed, the direction of the scaled displacement vector \vec{S}_{R→E} (632) giving the position of the effective user input 623 is correspondingly changed. This allows the user to interact with the Dave contact even whilst providing the present user input within the area of the Bob contact user interface element. In addition, it will be appreciated that because the scale factor f is less than one, a relatively large movement of the present input position 622 is required to move the displaced effective input position 623. This may allow the user to position the effective input position more accurately (than, for example, interacting directly with the screen at the interaction position).

When the user sees that the effective input position 623 is located within the desired Dave contact user interface element 652, the user completes the dragging input gesture. In response to detecting completion of the dragging input gesture, the apparatus is configured to enable selection of the user interface element at the effective user input position. In this case, the Dave contact user interface element 652 is selected. This is shown in FIG. 6d.

It will be appreciated that, by providing for an effective user input which is displaced from the present user input may allow the user to more clearly see with which portion of the graphical user interface he is interacting (e.g. as it would not be obscured by his finger or other stylus in the case of a touch screen user interface).

It will be appreciated that the apparatus may be configured to enable the user to interact with a graphical user interface at a determined displaced effective input position on the screen in response to the apparatus/device being put in a particular displaced input mode. For example, a particular gesture or a particular button press could activate the displaced input mode (e.g. and to enable display of an arrow indicating the position of the displaced input).

It will be appreciated that providing for an effective user input which is displaced from the present user input may help with one-handed usage of the device as the user could use this displaced interaction to reach icons that she'd not be able to reach or have trouble reaching with the holding hand's finger. Also on a large display (e.g. a surface or a large touch screen) the displaced interaction may allow far-away icons and elements to be reached.

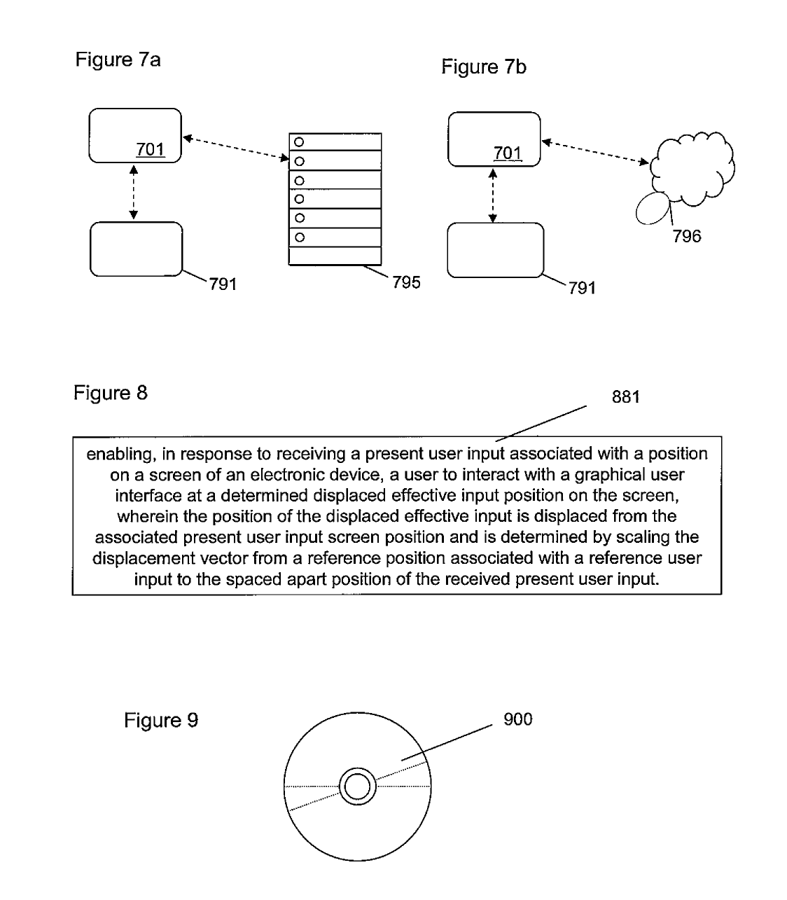

FIG. 7a shows an example of an apparatus in communication with a remote server. FIG. 7b shows an example of an apparatus in communication with a “cloud” for cloud computing. Such communication with a remote computing element may be via a communications unit, for example. In FIGS. 7a and 7b, the apparatus 701 (which may be apparatus 101, 201 or 301) is in communication with another device 791, such as a display, microphone, speaker, or camera. Of course, the apparatus 701 and device 791 may form part of the same apparatus/device, although they may be separate as shown in the figures.

FIG. 7a shows the remote computing element to be a remote server 795, with which the apparatus may be in wired or wireless communication (e.g. via the internet, Bluetooth, a USB connection, or any other suitable connection). In FIG. 7b, the apparatus 701 is in communication with a remote cloud 796 (which may, for example, by the Internet, or a system of remote computers configured for cloud computing). A portable electronic device may be configured to download data from a remote server 795 or a cloud 796. The determination of the displaced effective input position may be performed by the server 795/cloud 796. In other example embodiments, the server 795/cloud 796 may enable a user to interact with a graphical user interface at a displaced effective input position as disclosed herein.

FIG. 8 illustrates a method according to an example embodiment of the present disclosure. The method comprises enabling 881, in response to receiving a present user input associated with a position on a screen of an electronic device, a user to interact with a graphical user interface at a determined displaced effective input position on the screen, wherein the position of the displaced effective input is displaced from the associated present user input screen position and is determined by scaling the displacement vector from a reference position associated with a reference user input to the spaced apart position of the received present user input.

FIG. 9 illustrates schematically a computer/processor readable medium 900 providing a program according to an example embodiment. In this example, the computer/processor readable medium is a disc such as a Digital Versatile Disc (DVD) or a compact disc (CD). In other example embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some example embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such example embodiments can include a reduced requirement to download data when further functionality is required for a device, and this can be useful in examples where a device is perceived to have sufficient capacity to store such pre-programmed software for functionality that may not be enabled by a user.

Any mentioned apparatus/elements/processor may have other functions in addition to the mentioned functions, and that these functions may be performed by the same apparatus/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some example embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/example embodiments may consist of any such individual feature or combination of features. In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example embodiments may be incorporated in any other disclosed or described or suggested form or example embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
a processor; and
a memory including computer program code,
the memory and the computer program code configured, with the processor, to cause the apparatus to perform at least the following:
enable, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling a displacement vector from a reference position associated with a reference user input to the spaced apart position of the received present user input.

2. The apparatus of claim 1, wherein the apparatus is configured to determine the position of the displaced effective input with respect to the reference position by scaling the displacement vector by a factor less than 1.

3. The apparatus of claim 1, wherein the apparatus is configured to determine the position of the displaced effective input with respect to the reference position by scaling the displacement vector by a factor greater than 1.

4. The apparatus of claim 1, wherein the apparatus is configured to allow the user to interact with the graphical user interface at a determined displaced effective input position on the screen by:
interacting with graphical user interface elements located at the determined effective input position prior to the present user input being received.

5. The apparatus of claim 1, wherein the apparatus is configured to allow the user to interact with the graphical user interface at a determined displaced effective input position on the screen by:
selecting graphical user interface elements at the determined effective input position.

6. The apparatus of claim 1, wherein the apparatus is configured to allow the user to interact with the graphical user interface at a determined displaced effective input position on the screen by:
moving graphical user interface elements to the determined effective input position.

7. The apparatus of claim 1, wherein the reference position corresponds to the position of a previously received user input, the previously received user input being a user input which was provided before the present user input.

8. The apparatus of claim 1, wherein the reference position corresponds to be the position of a simultaneously or concurrently received user input, the simultaneously or concurrently received user input being a user input received at least partially overlapping in time with the present user input.

9. The apparatus of claim 1, wherein the position of the effective input position is indicated on the screen by an effective input position indicator.

10. The apparatus of claim 1, wherein the displacement vector between the effective input position and the received present user input position is indicated by an arrow.

11. The apparatus of claim 1, wherein the apparatus is configured to enable display an interaction zone, the interaction zone configured to:
be smaller than the screen or a particular screen portion; and
be orientated with respect to the reference position,
such that a user input position within the interaction zone is associated with a corresponding determined displaced effective input position on the screen or the particular screen portion.

12. The apparatus of claim 11, wherein the particular screen portion corresponds to a window or is a portion of the screen dedicated to a particular application, file, or software widget.

13. The apparatus of claim 1, where in the position of the at least one of the received present user input, the reference position and the effective input may be defined with respect to the screen.

14. The apparatus of claim 1, wherein the position of the at least one of the received present user input, the reference position and the effective input may be defined with respect to content displayed on the screen.

15. The apparatus of claim 1, wherein the apparatus is configured to receive a said user input associated with a position on a screen from at least one of:
a mouse;
a keyboard;
a joystick;
a touchpad; and
a touch screen.

16. The apparatus of claim 1, wherein the apparatus comprises the screen.

17. The apparatus of claim 1, wherein the apparatus is the electronic device, a portable electronic device, a laptop computer, a mobile phone, a Smartphone, a tablet computer, a personal digital assistant, a digital camera, a watch, a server, a non-portable electronic device, a desktop computer, a monitor, a server, a wand, a pointing stick, a touchpad, a touch-screen, a mouse, a joystick or a module/circuitry for one or more of the same.

18. A method comprising:
enabling, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling the displacement vector from a reference position associated with a reference user input to the spaced apart position of the received present user input.

19. A non-transitory computer readable medium comprising computer program code configured to:
enable, in response to receiving a present user input associated with a position on a screen of an electronic device, a user to interact with a graphical user interface at a determined displaced effective input position on the screen,
wherein the position of the displaced effective input is displaced from the associated present user input screen position and is determined by scaling the displacement vector from a reference position associated with a reference user input to the spaced apart position of the received present user input.
